(19) United States
(12) Patent Application Publication
(10) Pub. No.: US 2026/0072845 A1
(43) Pub. Date: Mar. 12, 2026

(54) SYSTEM AND METHOD FOR DATA PLACEMENT AND PREFETCH USING DATA REFERENCE PREDICTION IN DATA MANAGEMENT SSD

(71) Applicant: Samsung Electronics Co., Ltd., Gyeonggi-do (KR)

(72) Inventors: Ho Bin LEE, San Jose, CA (US); Jing YANG, Glen Allen, VA (US); Rekha PITCHUMANI, Oak Hill, VA (US)

(21) Appl. No.: 19/323,839

(22) Filed: Sep. 9, 2025

Related U.S. Application Data
(60) Provisional application No. 63/692,378, filed on Sep. 9, 2024.

(51) Int. Cl. G06F 12/0862; G06F 12/1036

(52) U.S. Cl. CPC G06F 12/0862; G06F 12/1036; G06F 2212/6024

(57) ABSTRACT

A system and a method are disclosed for managing data placement and prefetching in a solid-state drive (SSD). The method includes receiving a memory access request; predicting a memory address, based on the memory access request, using a prediction model trained on access patterns; and prefetching data associated with the predicted memory address from the SSD, based on the memory access request and a data placement group.

### CROSS-REFERENCE TO RELATED APPLICATION

This application claims the priority benefit under 35 U.S.C. § 119(e) of U.S. Provisional Application No. 63/692,378, filed on Sep. 9, 2024, the entire contents of which are incorporated herein by reference.

### TECHNICAL FIELD

The disclosure generally relates to data storage systems, specifically for data storage systems. More particularly, the subject matter disclosed herein relates to improvements in data placement and prefetching within solid state drive (SSD) data storage systems, driven by machine learning (ML)-based data reference prediction and address reference tracking.

### BACKGROUND

The present disclosure relates to data storage technology, specifically improvements for data storage systems (e.g., SSDs). Such data storage systems are designed to integrate enhanced access speed with SSD storage, providing benefits in latency and performance for high-demand data applications. In typical SSD data storage systems, data is placed into available flash media using, for example, a static wear-leveling policy, and prefetch operations are limited to static patterns (e.g., sequential or stride-based), leading to suboptimal data access efficiency.

To solve this problem and improve data access capabilities, other solutions primarily rely on static data placement with simple prefetching schemes. These approaches often scatter data across storage media, resulting in high write amplification, increased garbage collection (GC) activity, and lower system performance due to long-tail latency. Other prefetching methods, based on a limited set of access patterns, also result in low prefetch hit rates, which reduce overall bandwidth efficiency.

One issue with the above approach is that static placement and prefetching methods fail to adapt to dynamic or application-specific data access patterns. This limitation causes inefficient storage utilization, excessive write amplification, and frequent GC operations, leading to performance bottlenecks and reduced SSD longevity.

### SUMMARY

To overcome these issues, systems and methods are described herein for utilizing ML-based data reference prediction combined with dynamic address reference tracking. Various embodiments disclosed herein employ a sequence-to-sequence (Seq2Seq) ML model to predict data access sequences based on historical address references, dynamically identifying related data. This predicted relationship allows related data to be stored contiguously within the same flash block or stripe, minimizing fragmentation and write amplification. Additionally, the ML model-based prefetching adapts to specific application patterns, leading to higher prefetch hit rates and improved read bandwidth.

The above approaches improve on previous methods because they reduce write amplification, lower long-tail latency, and increase storage performance and longevity. By dynamically adjusting data placement and prefetching to match real-time access patterns, one or more solutions disclosed herein enhance efficiency in data-intensive applications.

In an embodiment, a method for managing data placement and prefetching in an SSD comprises receiving a memory access request; predicting a memory address, based on the memory access request, using a prediction model trained on access patterns; and prefetching data associated with the predicted memory address from the SSD, based on the memory access request and a data placement group.

In an embodiment, a system for managing data placement and prefetching in an SSD comprises a processor configured to receive a memory access request; a storage unit storing a prediction model trained on access patterns and configured to predict a memory address based on the memory access request; and a prefetching module configured to prefetch data associated with the predicted memory address from the SSD, based on the memory access request and a data placement group.

### BRIEF DESCRIPTION OF THE DRAWING

In the following section, the aspects of the subject matter disclosed herein will be described with reference to exemplary embodiments illustrated in the figures, in which:

FIG. 1 is a block diagram illustrating a data management-SSD, according to an embodiment;

FIG. 2 is a block diagram illustrating a data management-SSD, according to an embodiment;

FIG. 3 is a block diagram illustrating a data management-SSD, according to an embodiment;

FIG. 4 is a block diagram illustrating address reference tracking, according to an embodiment;

FIG. 5 is a block diagram illustrating an address reference scanner, according to an embodiment;

FIG. 6 is a block diagram illustrating related address prediction, according to an embodiment;

FIG. 7 is a block diagram illustrating an example of related address prediction via an Seq2Seq model, according to an embodiment;

FIG. 8 is a flowchart illustrating a method for data placement and prefetching using data placement prediction, according to an embodiment; and

FIG. 9 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“Garbage collection,” (or “GC”) as used herein, refers to the process in SSDs where invalid or outdated data is removed to free up storage space. This process typically involves identifying blocks that contain both valid (in-use) and invalid (outdated) data, moving the valid data to a new block, and erasing the original block to make it available for future writes. Some examples of GC processes include SSD maintenance cycles that consolidate scattered data and prepare storage for new data writes.

“Page,” as used herein, refers to the smallest unit of data storage in an SSD, typically ranging from 4 KB to 16 KB. Data can be written to individual pages, but they cannot be erased independently and must be erased in groups within a block. Some examples of a “page” include rows of data within a flash storage block that are written sequentially as new data is stored.

“Block,” as used herein, refers to a larger unit of data storage in an SSD that includes multiple pages, such as between 64 and 256 pages. A block is the smallest unit that can be erased in an SSD, which therefore affects the process of data consolidation during GC. Some examples of “block” structures include flash memory regions that group pages together for efficient storage management.

“Write amplification,” as used herein, refers to a feature in SSDs where the actual number of write operations to the storage media is higher than the number of logical write requests made by the host system. Write amplification often results from processes like GC, where data must be rewritten multiple times to manage storage effectively. Some examples of “write amplification” include situations where repeated writes occur during data consolidation in SSDs, leading to additional wear on memory cells.

“Prefetching,” as used herein, refers to the process of predicting and loading data into cache memory before it is actually requested by the application, based on expected access patterns. Prefetching aims to improve read performance by anticipating data needs and retrieving it proactively. Some examples of “prefetching” are caching data based on sequential access patterns or stride-based patterns in conventional SSD systems.

“SSD data storage systems”, as used herein, refers to a type of SSD that provides a memory-like interface to storage, allowing for faster access to data compared to traditional storage drives. SSD data storage systems are often used in high-performance applications that require rapid data retrieval, such as in data centers and enterprise environments. Some examples of “SSD data storage system” implementations include devices that use dynamic random-access memory (DRAM) cache and data placement strategies to mimic the behavior of main memory.

A “sequence-to-sequence” (or “Seq2Seq”) model, as used herein, refers to a type of ML model that processes an input sequence and generates a corresponding output sequence. An Seq2Seq model typically includes an encoder and a decoder, where the encoder processes the input sequence and transforms it into a fixed-size context or latent representation, which is then used by the decoder to generate the output sequence. Some examples of Seq2Seq models include those using recurrent neural networks (RNNs) such as long short-term memory (LSTM) or gated recurrent units (GRUs), as well as attention-based transformer models.

The present disclosure introduces a system for enhancing data organization and retrieval in SSD data storage systems by applying ML techniques to predict data access patterns. In SSD data storage systems, data placement often follows fixed patterns, leading to scattered data storage, high write amplification, and increased GC operations. These inefficiencies slow down data retrieval and reduce the overall performance of the SSD. The proposed system uses ML models to dynamically identify relationships between data access requests, enabling more efficient data grouping and placement.

According to an embodiment, an Seq2Seq model that learns from historical access sequences to predict future data requests may be used. By grouping related data in contiguous storage locations based on these predictions, the system reduces fragmentation and minimizes the frequency of GC cycles. Additionally, instead of relying on static prefetching strategies, the system can dynamically adjust prefetch operations to specific access patterns, improving read hit rates and reducing access latency.

This approach provides an improvement in storage efficiency and access speed compared to traditional methods. By proactively managing data placement and prefetching, various embodiments disclosed herein not only reduce write amplification and latency but also extend the lifespan of SSD data storage systems. This is valuable for applications requiring consistent, high-speed data access, such as data centers, cloud storage, and other enterprise environments.

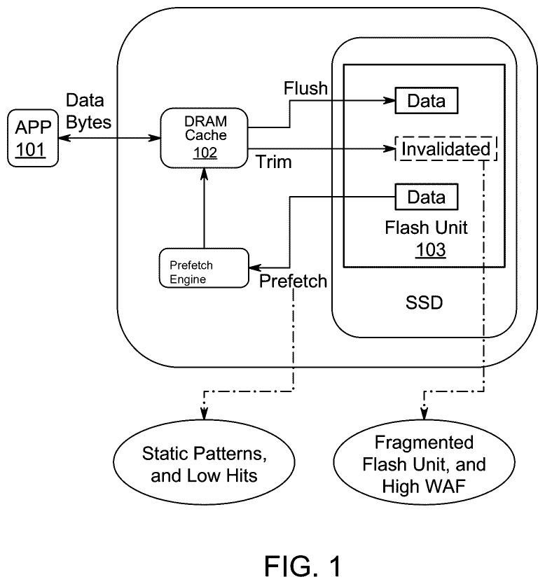

FIG. 1 is a block diagram illustrating a data management-SSD, according to an embodiment.

Referring to FIG. 1, the basic architecture and operation of an SSD data storage system, which integrates a memory interface with backing SSD storage to provide a high-performance data storage solution, is illustrated. In this setup, applications (“APP 101” in FIG. 1) interface with the SSD data storage system, transferring data through a DRAM cache layer 102, which temporarily holds data to optimize access speeds. Data written by the application is stored in flash memory units 103, which are part of the SSD's main storage area. Flash units are organized into blocks and pages, with a wear-leveling policy that distributes data across the flash media to balance usage and prolong the lifespan of each memory cell.

However, this wear-leveling policy may operate independently of the data's access patterns, resulting in scattered data storage throughout the SSD. Such fragmentation increases write amplification, meaning that multiple writes are required to complete data updates, which, in turn, leads to frequent GC cycles where fragmented blocks must be consolidated.

As mentioned above, a GC cycle is a maintenance process used in SSDs to free up storage space by consolidating valid data and erasing blocks that include invalid or outdated data. Over time, as data in the SSD is updated or deleted, certain pages within the storage blocks become invalid, meaning they are no longer needed. However, unlike other hard drives, SSDs typically can only erase data in large block units, not individual pages, which creates a challenge when managing space efficiently.

To address this, the SSD periodically performs a GC cycle. In this process, the SSD identifies blocks that contain a combination of valid (still-needed) and invalid (outdated) data. It then copies the valid data to a new block, consolidating it and freeing up space in the original block. After all valid data has been moved, the SSD erases the entire original block, making it available for new data writes.

GC is necessary in SSDs because a write operation can only occur on empty pages. Without GC, the SSD would quickly run out of writable space, even if much of the stored data were outdated. However, the GC process itself involves additional read and write operations, which can lead to write amplification, meaning that the SSD performs more physical writes than the logical writes requested by the system. This additional workload can reduce performance and cause long tail latency, where the SSD response time slows down significantly during GC activity. Over time, frequent GC cycles also wear down the flash memory cells, potentially reducing the lifespan of the SSD.

Efficiently managing GC should be considered for applications that require high performance. High GC activity can introduce delays, reduce storage efficiency, and shorten the drive's usable life. Various embodiments disclosed herein seek to reduce the frequency and impact of GC by grouping related data together and using ML for intelligent data placement, minimizing the fragmentation that typically triggers frequent GC cycles.

Referring again to FIG. 1, the SSD data storage system may rely on data static prefetching techniques, which may refer to the process of predicting and loading data into cache memory before it is actually requested by an application, to anticipate future data requests. These techniques, typically featuring sequential or stride-based patterns, may be unable to adapt to more complex or application-specific data access patterns such as non-sequential and non-stride but repeating accesses. As a result, the prefetch mechanism often fails to predict the data that will be needed, leading to low prefetch hit rates and reduced bandwidth efficiency.

FIG. 1 also shows a flush operation, which writes data from DRAM cache to a flash unit and a trim operation, which marks data as invalid when it is no longer needed, signaling the GC process to clean up these sections during idle times. However, the combination of static data placement, wear-leveling, and limited prefetching methods often leads to inefficiencies in the form of high GC activity and long tail latency for data access. These limitations necessitate the need for a more sophisticated data management system within SSD data storage systems, one that can dynamically adapt to changing data access patterns to optimize both data placement and prefetching, thereby improving storage efficiency, access speed, and SSD durability.

In addition, FIG. 1 also illustrates a flush operation, which may refer to the process of transferring data from the DRAM cache 102 into the underlying flash memory units 103. A flush may be triggered, for example, when the cache reaches a capacity threshold, when a consistency or persistence requirement is received from the host application, and/or when the system prepares for a garbage collection cycle.

Accordingly, in FIG. 1, data is stored in backing SSDs according to a standard wear-leveling policy. This method scatters data across different flash units to balance wear across the storage cells. However, this scatter-based placement may not account for data relationships or access patterns, leading to increased write amplification and excessive GC activities. As shown, this setup often fragments data across multiple flash units, creating inefficiencies that result in higher write amplification factors (WAF) and contribute to long tail latency. Additionally, the prefetching approach in these types of SSD data storage systems can be static and limited to a few access patterns, such as sequential or stride-based patterns. This restrictive prefetching model leads to a low prefetch hit ratio, which reduces bandwidth utilization and overall read performance, because static schemes fetch data that often does not align with actual access requests, wasting cache space and forcing additional flash reads.

In contrast, one or more embodiments disclosed herein introduce an ML-based reference prediction and dynamic data placement strategy.

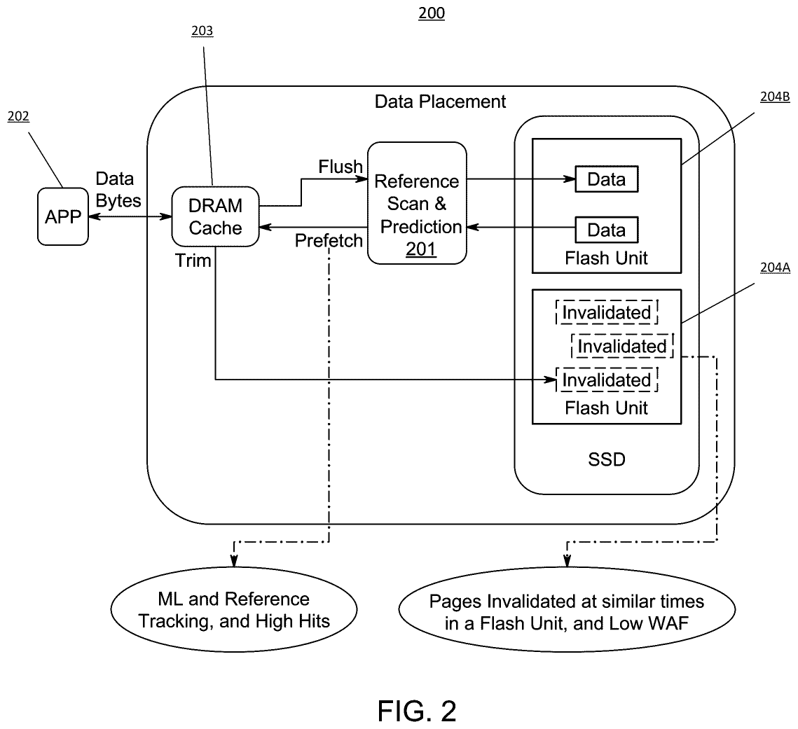

FIG. 2 is a block diagram illustrating a data management-SSD, according to an embodiment.

Referring to FIG. 2, instead of scattering data arbitrarily, the system 200 of FIG. 2 identifies related data through an address scan and ML-based reference prediction model 201. The system 200 in FIG. 2 receives data bytes from an application 202 and temporarily stores them in a dynamic random-access memory DRAM cache 203. A trim operation (Trim) may mark data as invalid when it is no longer needed. The data that is no longer needed may be transferred to a flash storage unit 204A. In addition, a flush operation (Flush) may transfer cached data into a flash storage unit 204B via the ML-based reference prediction model 201. A prefetch path (Prefetch) may proactively bring data into the cache 203 based on prediction outcomes. Within the reference scan and prediction model 201, related data may be detected and assigned for storage in the same flash unit, either at the block or stripe level, through a flexible data placement (FDP) approach. The related data assigned within a common placement group (e.g., storage in the same flash unit, either at the block or stripe level) can therefore be stored in contiguous locations in the SSD based on the data placement group. This grouping minimizes fragmentation, reduces write amplification, and lowers the frequency of GC activities, thereby improving latency and extending the SSD's lifespan. In addition, dynamic prefetching that uses ML models and address reference tracking can be used to predict data access patterns that are not limited to static patterns. This approach increases the prefetch hit ratio and improves bandwidth efficiency, resulting in higher read performance and a more responsive system.

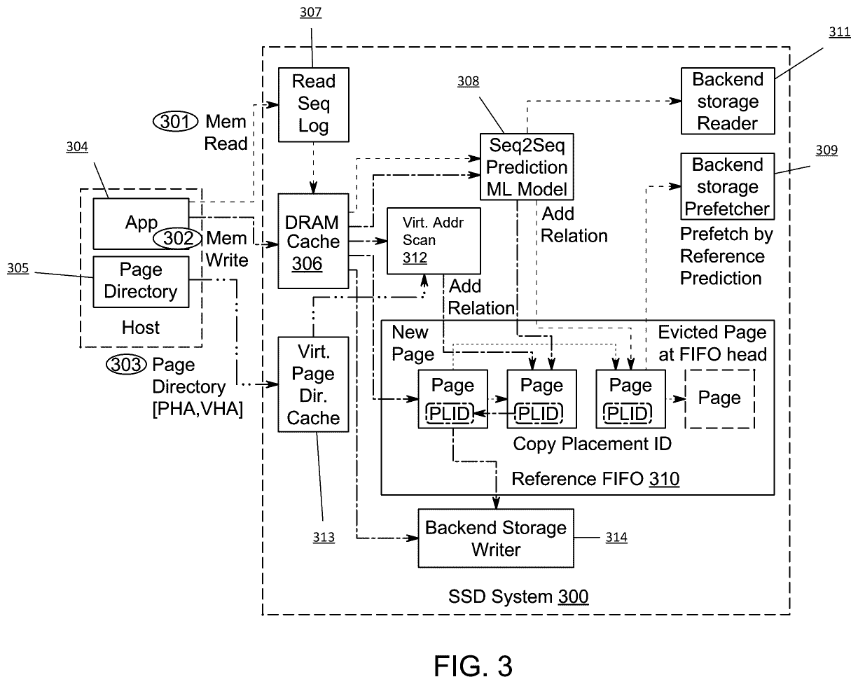

FIG. 3 is a block diagram illustrating a data management-SSD, according to an embodiment.

Referring to FIG. 3, this diagram outlines how the SSD data storage system 300 identifies related data patterns for both read and write operations and manages the data placement process accordingly.

An application 304 and a page directory 305 provide data to the system 300. A memory read path 301 and a memory write path 302 are shown, with page directory mapping information provided via a page directory interface path 303 that includes physical address (PHA) and virtual host address (VHA) entries.

In the read path 301, the system 300 logs read address sequences in a read sequence log 307, which records prior access patterns. These logged sequences are applied to the DRAM cache 306 and provided to a Seq2Seq prediction ML model 308. The model analyzes the sequences and predicts the next likely addresses to be accessed by encoding the input sequence of past addresses into a latent representation and then decoding that representation into a probability distribution over future addresses. In one embodiment, the Seq2Seq model may use recurrent units (e.g., LSTM or GRU) or an attention-based transformer architecture to capture temporal dependencies, assigning higher probability to addresses that historically occur after the observed sequence. Based on these predictions, the system 300 proactively prefetches related data according to a reference first-in-first-out (FIFO) list 310. A backend storage prefetcher 309 retrieves the predicted pages in advance, and a backend storage reader 311 reads the requested data.

In addition to predicting individual future addresses, the system 300 may prefetch based on a data placement group which can be identified by a data placement ID. Once related pages are assigned a placement identification (PLID), the prefetcher 309 may, upon a request for or prediction of any page carrying that PLID, proactively load one or more pages that share the same PLID from the reference FIFO list 310 into the DRAM cache 306. The selection of pages may depend on model-assigned probabilities, recency within the FIFO 310, or a prefetch depth parameter, so that group-level prefetching favors pages most likely to be accessed together.

For write operations, step 302 is applied. In this path, incoming data is temporarily buffered in the DRAM Cache 306. A virtual address scan module 312 examines the data and detects virtual addresses, by, for example, parsing the incoming byte stream and applying a range filter that identifies address-sized fields within valid address ranges. Each detected virtual address may then be mapped to a physical address based on a virtual page directory cache 313, which maintains a table of recent virtual-to-physical translations. The cache may use hashing or tag-based matching to locate the corresponding physical entry, enabling the system 300 to determine whether the new write references an existing page or a page within a related block. When the scan identifies related pages, the system 300 copies PLID from the related data and assigns it to the new page, grouping them into the same flash unit or block. FIG. 3 illustrates several pages labeled with PLIDs, which are inserted into the FIFO list 310 to manage ordering. A backend storage writer 314 then groups these pages to flash storage. In the event that a page at the head of the FIFO list 310 is no longer needed, it is removed, making space for new data without disrupting the existing data storage.

In step 303, virtual-to-physical address mapping information provided by the page directory 305 is transmitted via a compute express link (CXL) to the virtual page directory cache 313 in the SSD system 300.

Accordingly, the system 300 improves data placement and prefetching efficiency. The Seq2Seq ML model and Virt. Addr Scan module work together to predict and group related data, while the reference FIFO and data placement ID mechanisms ensure that data is physically organized within the flash memory.

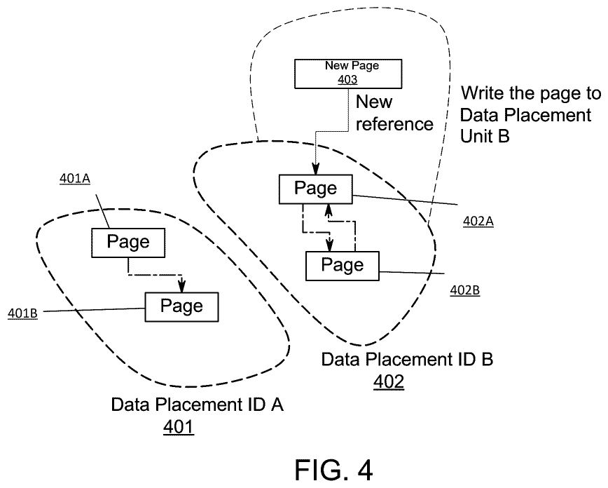

FIG. 4 is a block diagram illustrating address reference tracking, according to an embodiment.

Referring to FIG. 4, the address reference tracking process is illustrated, which is a component of the system's strategy for efficient data placement in the SSD data storage system. Address reference tracking is used to organize related data pages within specific placement groups to minimize data fragmentation, reduce write amplification, and improve system efficiency.

In FIG. 4, two placement groups, data placement ID A 401 and data placement ID B 402 are shown, each including a set of pages that are stored together due to their related access patterns. Data placement ID A 401 includes pages 401A and 401B and data placement ID B 402 includes pages 402A and 402B. When a new data page 403 is generated, it is added to the reference FIFO queue. The system then examines whether this new page 403 has references to existing pages 402A and/or 402B in the reference FIFO, indicating a relationship with previously stored data. If such a reference is found, the new page 403 is assigned the same data placement ID as the related pages (e.g., page 402A and/or page 402B in data placement ID B 402), ensuring that it is written to the same flash unit or block as its related data. This approach clusters related data physically close together, which helps reduce the need for repeated writes across different blocks, thereby lowering write amplification and improving storage efficiency.

If no referencing page is found within the reference FIFO, this indicates that the new data page has no clear relationship to existing data, and the system assigns a new data placement ID to the page. In this case, the page will initiate a new placement group, forming a separate cluster of data that can later be joined by other related pages if any new data references it. This flexible placement method allows the SSD to adapt dynamically to varying data access patterns to optimize data organization as new data is written. By embedding references between related pages and tracking them within the FIFO structure, the system effectively manages data placement in a way that minimizes fragmentation and reduces the frequency and impact of GC cycles.

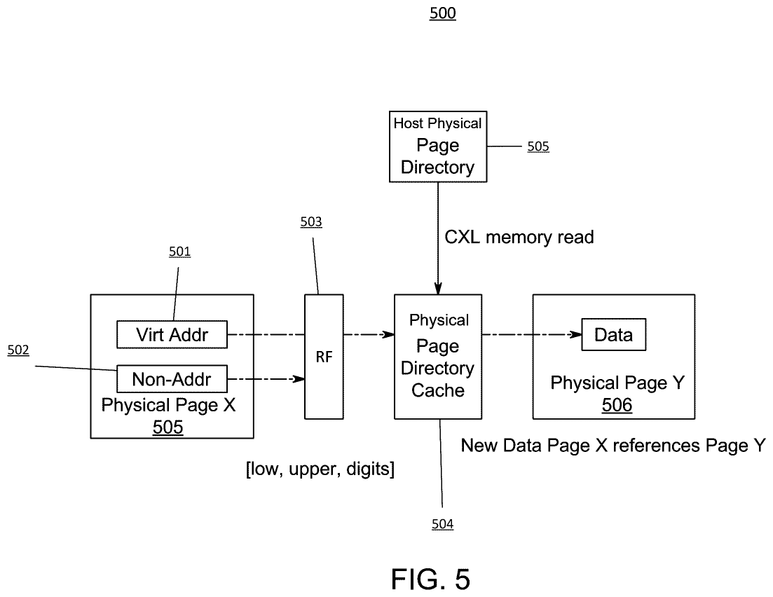

FIG. 5 is a block diagram illustrating an address reference scanner, according to an embodiment.

Referring to FIG. 5, the address reference scanner 500 includes a virtual address input 501 and a non-address input 502, which are shown in a physical data page X 505. These inputs are processed by a range filter (RF) 503 that may validate whether the detected values fall within a predefined addressable range. The output of the RF 503 is provided to a physical page directory cache 504, which stores virtual-to-physical translation information. The physical page directory cache 504 may be synchronized with a host physical page directory 505 accessed via a CXL memory read. The system further includes a physical data page Y 506 that represents an existing data page in storage.

The address reference scanner 500 may be used to optimize data placement by dynamically identifying relationships between newly written data and existing data in the SSD. The address reference scanner 500 processes new data as it is written to storage by scanning the incoming byte stream (e.g., including virtual address input 501 and/or non-address input 502) to identify any virtual addresses. This scanning is performed through the range filter 503 to verify whether one or more addresses fall within a predefined valid range of virtual addresses, specified by parameters such as a low bound, high bound, and number of address digits. By filtering addresses in this way, the system ensures that only relevant addresses within the appropriate range are processed for reference tracking.

Once potential virtual addresses are identified, the address reference scanner 500 may use the physical page directory cache 504 to translate these virtual addresses into physical addresses. The virtual-to-physical address translation allows the address reference scanner 500 to locate the actual physical storage locations associated with these addresses. The host physical page directory 505 (accessed via a CXL memory read) may maintain a mapping of all physical pages in the system, ensuring accurate address translation. Through this process, each new data page is checked to see if it references any existing physical pages stored in the SSD or otherwise exhibits a relationship to one or more prior pages, such as sharing a PLID or address range.

If a match is found, the address reference scanner 500 may embed a reference to the existing data page within the new page's metadata and adds it to the reference FIFO. This relationship links the new data page (Page X 505) with an existing data page (Page Y 506), allowing the system to recognize that they are related. By recording these relationships, the SSD can assign a shared data placement ID or store these pages within the same physical block or unit. This approach enhances data locality, reduces fragmentation, and minimizes the need for frequent GC.

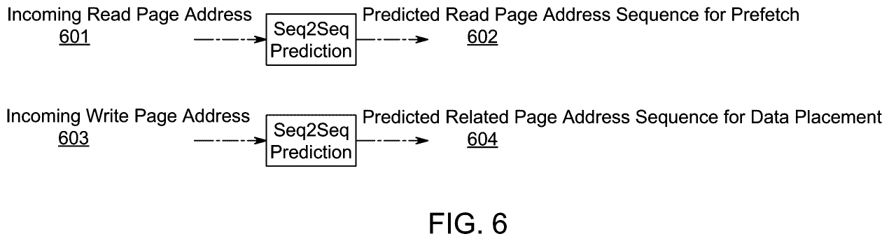

FIG. 6 is a block diagram illustrating related address prediction, according to an embodiment.

Referring to FIG. 6, a related address prediction functionality is shown, which uses ML to improve data placement and prefetching in SSD data storage systems. The system uses Seq2Seq models, which are trained on each application's historical read sequences of virtual addresses. These models, often based on LSTM networks or attention-based architectures, are designed to capture temporal relationships in sequential data, making them well-suited to predict future access patterns.

Once trained, the Seq2Seq model can predict the next likely read addresses and their associated probabilities based on an incoming read sequence. This capability is illustrated in FIG. 6, where an incoming read page address 601 is fed into the Seq2Seq prediction model, resulting in a predicted read page address sequence 602. By proactively identifying future read addresses, the system can prefetch related data in advance, improving read hit rates and reducing latency. This predictive prefetching, tailored to the access patterns of individual applications, improves data retrieval by ensuring that related data is readily available when it is needed.

The Seq2Seq model is also applied to write operations to enhance data placement. When an incoming write page address 603 is input to the model, the output includes a sequence of predicted related page addresses 604 along with similarity probabilities. These predictions allow the system to interpret the output addresses as having similar lifetimes, meaning they are likely to be accessed together or within close succession. As a result, the system can store these related addresses in the same physical location, or assign them a shared PLID, ensuring that related data is physically organized within the same flash unit. By grouping data with similar lifetimes, the system reduces write amplification, minimizes the frequency of GC, and enhances data locality.

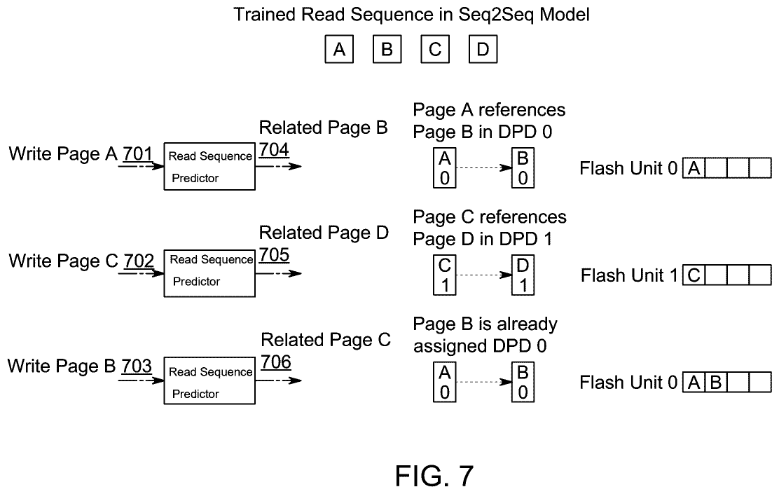

FIG. 7 is a block diagram illustrating an example of related address prediction via a Seq2Seq model, according to an embodiment.

Referring to FIG. 7, an example of related address prediction via a Seq2Seq model in the context of data placement and organization within an SSD data storage system is shown. The Seq2Seq model has been trained on a read sequence pattern of virtual addresses labeled A, B, C, and D. Using this trained sequence, the Seq2Seq model predicts related addresses for incoming write operations, ensuring that data with similar access patterns is placed in proximity within the SSD.

The system handles three incoming write operations: writing Page A 701, writing Page C 702, and writing Page B 703. When Page A 701 is written, the read seq predictor (e.g., the Seq2Seq model) identifies that Page B 704 is related to Page A 701 based on the trained sequence. Therefore, the system establishes a reference from Page A 701 to Page B 704, assigning them both to data placement ID (DPD) 0 and storing them within Flash Unit 0. In one embodiment, the SSD controller internally assigns the DPD and inserts the identifier into the page metadata as the write is processed, so that the host remains unaware of the grouping operation. In another embodiment, the assigned DPD may be communicated back to the host through mapping information, enabling the host to include the identifier in subsequent write requests.

Similarly, when Page C 702 is written, the Seq2Seq model predicts that it is related to Page D 705. This leads to a grouping where Page C 702 and Page D 705 are assigned to DPD 1 and placed together in Flash Unit 1. This grouping strategy ensures that data with similar lifetimes or access patterns are stored together, optimizing storage efficiency.

When Page B 706 is written again, the system detects that Page B 704 is already assigned to DPD 0, where it is associated with Page A 701 in Flash Unit 0. In one embodiment, the SSD controller internally assigns the DPD and inserts the identifier into the page metadata as the write is processed, so that the host remains unaware of the grouping operation. In another embodiment, the assigned DPD may be communicated back to the host through mapping information, enabling the host to include the identifier in subsequent write requests. Accordingly, since the Seq2Seq model has established this grouping, the system avoids redundant data placement and maintains the organizational structure that links Page B 704 with Page A 701.

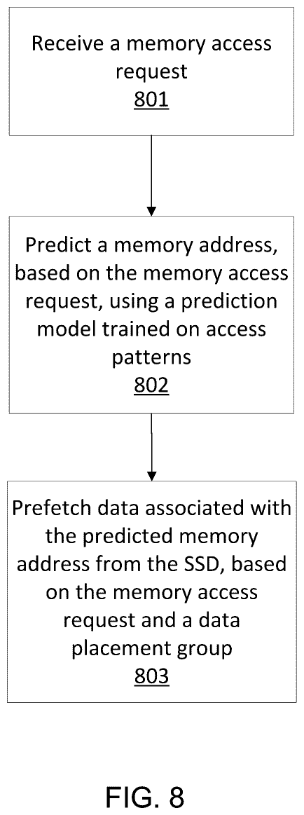

FIG. 8 is a flowchart illustrating a method for data placement and prefetching using data placement prediction, according to an embodiment.

The method of FIG. 8 may be performed on a variety of electronic devices that incorporate SSD technology. For example, the method may be executed by an SSD controller embedded within a storage device, by firmware modules running on a processor of the SSD, or by a host system processor (e.g., a server, desktop computer, or mobile device) configured to interact with the SSD over a high-speed interface such as CXL.

Referring to FIG. 8, in step 801, the device receives a memory access request. The memory access request may be received from a host application or operating system. The memory access request may correspond to a read or write operation and may include a virtual or physical address.

In step 802, the device predicts a memory address based on the received request, using a prediction model trained on prior access patterns. In one embodiment, the prediction model is a Seq2Seq machine learning model configured to analyze historical address sequences and generate a probability distribution of future addresses. The model may use an encoder to transform the observed sequence of past addresses into a latent representation and a decoder to output one or more candidate future addresses.

In step 803, the device prefetches data associated with the predicted memory address from the SSD, based on the memory access request and a data placement group. The data placement group may include data that is predicted to be accessed together that is stored in contiguous locations and/or associated with a common PLID. For example, when one page in the group is predicted, the system may proactively load other pages in the same group into cache. By prefetching based on the placement group, the SSD may reduce access latency.

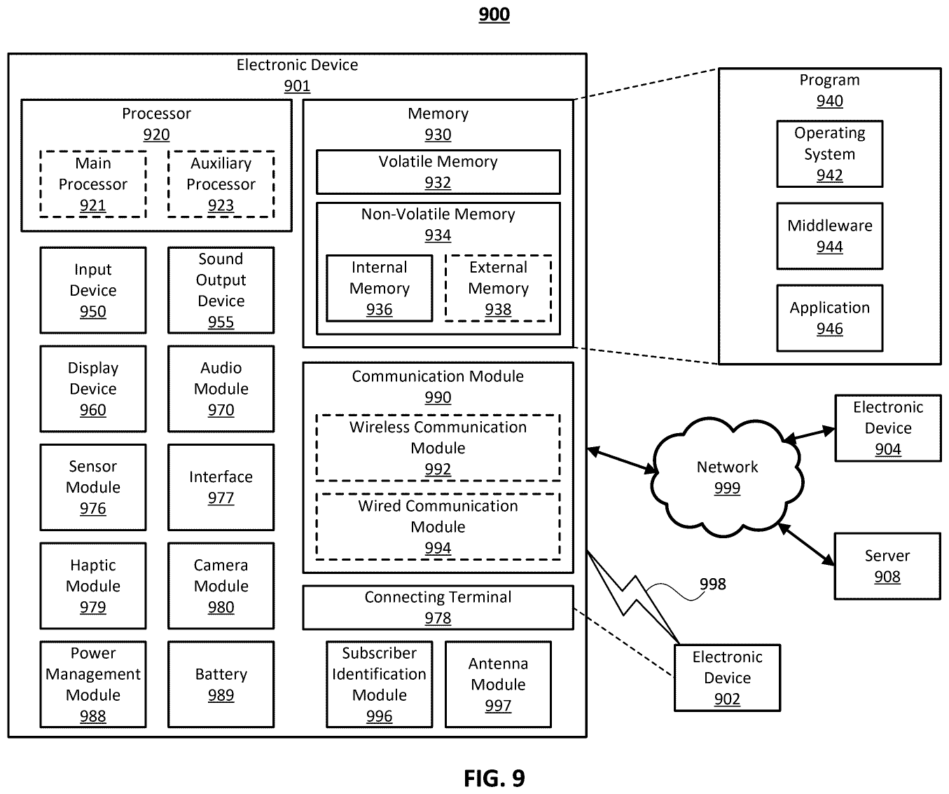

FIG. 9 is a block diagram of an electronic device in a network environment, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

In particular, the memory 930 and processor 920 may be used for implementing the advanced data placement and prefetching strategies described. The memory 930 includes storage resources for both volatile (e.g., DRAM cache) and non-volatile memory (e.g., flash storage in an SSD), enabling efficient data organization and retrieval within the SSD data storage system architecture. The processor 920, which includes integrated support for ML models, executes the Seq2Seq prediction models and address tracking functions that are used for the system's operation. By embedding ML capabilities within the processor, the system can dynamically predict data access patterns in real time, improving prefetching efficiency and data placement accuracy.

In addition, the communication module 990 facilitates data transfer and coordination with external devices or servers. For example, this module enables the SSD data storage system to interact with a host device or cloud server over a network, exchanging address mapping information and optimizing storage management based on real-time access patterns. The communication module can also support CXL, a high-speed interface that enables memory sharing between the host and storage device. This connectivity allows the SSD data storage system to transmit virtual-to-physical address mappings and data placement updates to the host system seamlessly, which is beneficial for implementing the flexible data placement and reference tracking mechanisms.

The power management module 988 and battery 989 components are also relevant in the context of high-efficiency memory operations. The system's use of intelligent data placement and reduced GC frequency leads to fewer write cycles, thus conserving power and extending the device's operating time. By reducing write amplification, the system not only enhances the endurance of the memory cells but also lowers the overall energy consumption required for data maintenance and retrieval. This energy efficiency is beneficial for portable devices or large data centers, where power management is a consideration. These improvements in data handling and resource optimization make the SSD data storage system more effective and reliable for high-demand storage environments.

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH^{TM}, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for managing data placement and prefetching in a solid-state drive (SSD), the method comprising:
receiving a memory access request;
predicting a memory address, based on the memory access request, using a prediction model trained on access patterns; and
prefetching data associated with the predicted memory address from the SSD, based on the memory access request and a data placement group.

2. The method of claim 1, further comprising:
grouping data predicted by the prediction model to be accessed together to form the data placement group.

3. The method of claim 1, further comprising embedding references between the data within the data placement group.

4. The method of claim 1, wherein the prediction model is a sequence-to-sequence (Seq2Seq) model trained using historical access patterns, including sequences of virtual addresses associated with application-specific data access patterns.

5. The method of claim 1, further comprising:
scanning incoming data to detect virtual addresses and translating the virtual addresses to physical addresses using a page directory cache.

6. The method of claim 1, further comprising:
assigning a data placement identification (ID) to the data associated with the predicted memory address based on an access pattern similarity threshold.

7. The method of claim 1, further comprising:
removing the data from a cache based on a first-in-first-out (FIFO) order within the data placement group.

8. The method of claim 1, further comprising:
applying a range filter to the predicted memory address to maintain a valid range of address references.

9. The method of claim 1, further comprising:
transmitting virtual-to-physical address mapping information to a host device over a compute express link (CXL) interface.

10. The method of claim 1, further comprising:
storing data in contiguous locations in the SSD based on the data placement group.

11. A system for managing data placement and prefetching in a solid-state drive (SSD), comprising:
a processor configured to receive a memory access request;
a storage unit storing a prediction model trained on access patterns and configured to predict a memory address based on the memory access request; and
a prefetching module configured to prefetch data associated with the predicted memory address from the SSD, based on the memory access request and a data placement group.

12. The system of claim 11, wherein the processor is further configured to group data predicted by the prediction model to be accessed together to form the data placement group.

13. The system of claim 11, wherein the processor is further configured to embed references between the data within the data placement group.

14. The system of claim 11, wherein the prediction model is a sequence-to-sequence (Seq2Seq) model trained using historical access patterns, including sequences of virtual addresses associated with application-specific data access patterns.

15. The system of claim 11, further comprising:
an address scanner configured to scan incoming data to detect virtual addresses and to translate the virtual addresses to physical addresses using a page directory cache.

16. The system of claim 11, wherein the processor is further configured to assign a data placement identification (ID) to the data associated with the predicted memory address based on an access pattern similarity threshold.

17. The system of claim 11, further comprising:
a cache in which data is removed from the cache based on a first-in-first-out (FIFO) order within the data placement group.

18. The system of claim 11, further comprising:
a range filter configured to apply a filter to the predicted memory address to maintain a valid range of address references.

19. The system of claim 11, further comprising:
a communication module configured to transmit virtual-to-physical address mapping information to a host device over a compute express link (CXL) interface.

20. The system of claim 11, wherein the data is stored in contiguous locations in the SSD based on the data placement group.
